(19) United States
(12) Patent Application Publication
(10) Pub. No.: US 2019/0305359 A1
(43) Pub. Date: Oct. 3, 2019

(54) INK FORMULATIONS AND METHODS FOR AN ELECTROLYTE FOR A SOLID STATE LITHIUM-ION BATTERY

(71) Applicant: Government of the United States, as represented by he Secretary of the Air Force, Wright-Patterson AFB, OH (US)

(72) Inventors: Lazarus J. DEINER, Brooklyn, NY (US); Michael A. ROTTMAYER, Springboro, OH (US); Thomas JENKINS, Beavercreek, OH (US); Thomas G. HOWELL, Lebanon, OH (US)

(73) Assignee: Government of the United States, as represented by the Secretary of the Air Force, Wright-Patterson AFB, OH (US)

(21) Appl. No.: 16/373,285

(22) Filed: Apr. 2, 2019

Related U.S. Application Data
(60) Provisional application No. 62/651,646, filed on Apr. 2, 2018.
(60) Provisional application No. 62/753,872, filed on Oct. 31, 2018.
(60) Provisional application No. 62/753,875, filed on Oct. 31, 2018.

(51) Int. Cl. H01M 10/056; H01M 10/0525; C08L 71/00; C08L 27/16; C08K 3/013; C08K 3/22; C08K 3/36

(52) U.S. Cl. CPC H01M 10/056; H01M 10/0525; C08L 71/00; C08L 27/16; C08K 3/013; H01M 2300/0071; C08K 3/36; C08K 2201/001; C08K 2003/2244; C08K 2003/2227; H01M 2300/0082; C08K 3/22

(57) ABSTRACT

A printable ink formulation for a solid lithium ion electrolyte. The printable ink composition includes a solvent having a boiling point under standard atmospheric conditions ranging from about 50° C. to about 225° C., a polymer, and a lithium salt. The composition is stable, has a viscosity ranging from about 1 mPa·s to 2000 mPa·s, and is printable by a drop-on-demand printer.

Pursuant to 37 C.F.R. § 1.78(a)(4), this application claims the benefit of and priority to prior filed co-pending Provisional Application Ser. Nos. 62/651,646 filed Apr. 2, 2018; 62/753,872 filed Oct. 31, 2018; and 62/753,875 filed Oct. 31, 2018. The disclosure of each provisional application is expressly incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to compositions and manufacturing methods for solid-state lithium-ion battery electrolytes and, more particularly, to compositions and manufacturing methods for electrolytes operable at room temperature.

### BACKGROUND OF THE INVENTION

Solid-state batteries have a wide range of applications including portable power, wearable power, electrical vehicle power, small air vehicle power, and large air vehicle auxiliary power. Unlike conventional batteries, solid-state batteries have no liquid or semi-liquid components and thus have enhanced safety features.

Conventional methods of manufacturing flexible solid-state batteries are not conducive to high volume, low cost production. Such limitations are due, in part, to a need to manufacture solid-state batteries under dry room or highly controlled atmosphere conditions. Dry room conditions are used to cast or deposit, and cure, an electrolyte composition, typically containing lithium, onto a film or transfer tape. The cured composition is then laminated to a conductor.

These methods typically produce films (i.e., electrolytes) having a thickness of about 100 μm or more. Because specific resistance of an electrolyte is proportional to the electrolyte thickness, decreasing electrolyte thickness from 100 μm to 100 nm would decrease the specific resistance by approximately three orders of magnitude. However, reducing the electrolyte thickness to less than 100 m using the conventional methods is difficult, at best.

As to conventional tape casting processes, the electrolyte is laminated to a conductor using a pressing process, which exhibits poor interfacial contact between the electrolyte and the conductor. However, this pressing process fails to produce seamless contact between the electrolyte and the conductor.

Still another disadvantage of conventional methods is the inability to easily vary a shape of the electrolyte. Accordingly, there is poor resolution in a Z-axis dimension in addition to poor resolution and flexibility in X- and Y-axes dimensions.

There remains a need for lithium-ion electrolyte compositions and simplified manufacturing methods that are capable of producing solid-state, lithium-ion electrolytes having conductivities approaching the conductivities of conventional solid-state, lithium-ion electrolytes. There also remains a need for lithium-ion electrolytes having micron-scale dimensions that may be readily varied along the X-axis, Y-axis, Z-axis, or combinations thereof.

### SUMMARY OF THE INVENTION

The present invention overcomes the foregoing problems and other shortcomings, drawbacks, and challenges of conventional lithium-ion electrolyte compositions and manufacturing methods. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention, a printable ink formulation for a solid lithium ion electrolyte includes a solvent having a boiling point under standard atmospheric conditions ranging from about 50° C. to about 225° C., a polymer, and a lithium salt. The composition is stable, has a viscosity ranging from about 1 mPa·s to 1000_mPa·s, and is printable by a drop-on-demand printer.

Other embodiments of the present invention are directed to a method for preparing a printable composition for a solid lithium ion electrolyte that includes mixing a solvent with a lithium salt. The solvent has a boiling point under standard atmospheric conditions ranging from about 50° C. to about 225° C. A polymer is introduced to the mixture, wherein the polymer has a molecular weight ranging from about 5 kDa to 5 MDa. The composition has a viscosity that ranges from 1 mPa·s to about 1000 mPa·s.

Still other embodiments of the present invention are directed to a method for preparing a printable composition for a solid lithium ion electrolyte that includes grinding together a lithium salt with an ionically-conducting, solid inorganic filler. A polymer and solvent solution is mixed, wherein the polymer has having a molecular weight ranging from about 5 kDa to 5 MDa, and the solvent has a boiling point under standard atmospheric conditions ranging from about 50° C. to about 225° C.

In view of the above, embodiments of the present invention provide a printable electrolyte composition for a solid lithium ion battery. The printable electrolyte composition includes a solvent having a boiling point under standard atmospheric conditions ranging from about 50° C. to about 225° C., a polymer, and a lithium compound selected from, for example, lithium trifluoromethane sulfonate, lithium bis(oxalato) borate, lithium difluoro(oxalato) borate, poly[(4-styrenesulfonyl)(trifluoro-methyl(S-trifluoromethyl-sulfonylimino)sulfonyl)imide], or other hydrophilic lithium salts (such as lithium bis(trifluoromethanesulfonyl)imide). The electrolyte composition is stable, has a viscosity ranging from about 1 mPa·s to 1000 mPa·s, and is printable by a drop-on-demand printing process under standard temperature and pressure conditions and in an atmosphere with a relative humidity ranging from about 20% to about 80%.

In another embodiment of the present invention, there is provided a method for printing an electrolyte composition for a solid lithium ion battery. The method includes mixing a solvent with a lithium compound to provide a solvent and lithium compound mixture. The solvent has a boiling point under standard atmospheric conditions ranging from about 50° C. to about 225° C. The lithium compound is selected from, for example, lithium trifluoromethane sulfonate, lithium bis(oxalato) borate, lithium difluoro(oxalato) borate, poly[(4-styrenesulfonyl)(trifluoro-methyl(S-trifluoromethyl-sulfonylimino)sulfonyl)imide], or other hydrophilic lithium salts (such as lithium bis(trifluoromethanesulfonyl)imide). A polymer having a molecular weight ranging from about 5 kDa to 5 MDa is provided. A printable electrolyte composition is prepared by combining the solvent and lithium compound mixture with the polymer such that the viscosity of the ink solution ranges from about 1 mPa·s to about 1000 mPa·s. The printable electrolyte composition is printed onto a conductive substrate in the absence of dry room conditions, such as under standard temperature and pressure. After printing, the solvent is evaporated to provide a solid lithium ion electrolyte on the conductor substrate.

In some embodiments, the solvent is selected from aliphatic hydrocarbons (such as octane), alcohols (such as 2-butanol or diacetone alcohol), t-butyl acetate, acetonitrile, ethylene carbonate, propylene carbonate, diethyl carbonate, dibutyl ketone, N-methyl-2-pyrrolidone, N-butyl pyrrolidone, n-propyl propionate, n-butyl propionate, methyl n-propyl ketone, methyl isobutyl ketone, methyl ethyl ketone, methyl isopropenyl ketone, methyl oleate, or combinations thereof.

In some embodiments, the polymer is selected from polyalkylene oxides or polyalkylene glycols including polyethylene oxide, polyethylene glycol, and polypropylene glycol; polyvinylidene difluoride; polypropylene glycol dimethyl ether; and polymethacrylic acid. In other embodiments, a polymer-to-lithium ratio (ethylene oxide moieties in the polymer-to-lithium ions in the lithium compound) in the electrolyte composition ranges from about 6:1 to about 40:1. In still other embodiments, a number average molecular weight of the polymer ranges from about 5 kDa to 5 MDa. In other embodiments, a weight ratio of solvent-to-polymer in the electrolyte composition ranges from about 2:1 to about 99:1.

In some embodiments, the electrolyte composition is printable by a drop-on-demand printer selected from an aerosol jet printer, a thermal jet printer, or a piezoelectric jet printer.

In other embodiments, the electrolyte composition includes an ionically-conducting, solid inorganic filler selected from ceramic fillers, an oxide filler, a sulfide filler, a phosphate-based lithium-ion conducting ceramic filler, and a phosphate-based lithium-ion conducting glass filler. In some embodiments, the filler is a ceramic filler selected from alumina and silica fillers. For still other embodiments, a super ionic conductor may be included.

Advantages of the disclosed embodiments include identification of solvents that are capable of dissolving high concentrations of polymers at or near standard atmospheric conditions; have high enough dielectric constants to dissociate lithium salts; have relatively low enough vapor pressure for processing and sufficiently high vapor pressure for drying; are non-toxic and environmentally benign. Another advantage of the disclosed embodiments is the absence of a post polymerization, curing, or sintering process for the solid electrolyte composition. A further advantage is that the compositions may be deposited by drop-on-demand printing techniques directly on a conductor substrate thereby eliminating the need to process the electrolyte separate from the conductor substrate.

Batteries prepared with electrolytes according to one or more embodiments of the present invention described herein may be used in a range of applications, such as power supplies that are portable, wearable, for electrical vehicles, for small air vehicles, or large air vehicle auxiliary power, to name a few. The printing techniques described herein may be applicable to a wide range of other, flexible energy devices including but not limited to solar cells, fuel cells, super capacitors, and flexible electronics, such as thin film transistors and circuit components. Moreover, electrolytes according to the embodiments of the present invention vary in a molecular weight range for a polymer comprising a portion thereof. Conventionally molecular weight ranges have been greater than those presented herein. Resultant compositions according to the conventional methods are too viscous to be sufficiently printed to build up a significant layer. Yet, polymers used in electrolytes according to the embodiments of the present invention are sufficient to maintain mechanical strength of the electrolyte.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a side-elevational, schematic view, in cross-section, of an aerosol jet printer suitable for use in methods of the present invention.

FIG. 2 is a graphical representation of printed film thickness for printable electrolyte compositions according to various embodiments of the present invention.

FIG. 3 is a Nyquist plot obtained from use of an electrolyte prepared in accordance with an embodiment of the present invention on battery grade aluminum foil

FIGS. 4, 5, 7, 8, 10, 11, 13, 14, 16, 17, and 19-22 are graphical representations of voltage as a function of charge capacity for seven charge/discharge cycles for coin batteries having an electrolyte prepared in accordance with embodiments of the present invention.

FIGS. 6, 9, 12, 15, and 18 are graphical representations of impedance measurements for interfacial and bulk resistances for a coin batteries having an electrolyte prepared in accordance with embodiments of the present invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

As used herein, the terms “standard conditions” and “standard temperature and pressure” (or “STP”) means conditions in which temperature ranges from about 20° C. to about 30° C. and pressure is about 1 atmosphere.

The term “standard atmospheric conditions” means conditions in which temperature ranges from about 20° C. to about 30° C., pressure is about 1 atmosphere, and relative humidity ranges from about 0% to about 80%.

The term “dry room conditions” means conditions in which relative humidity is 1% or less.

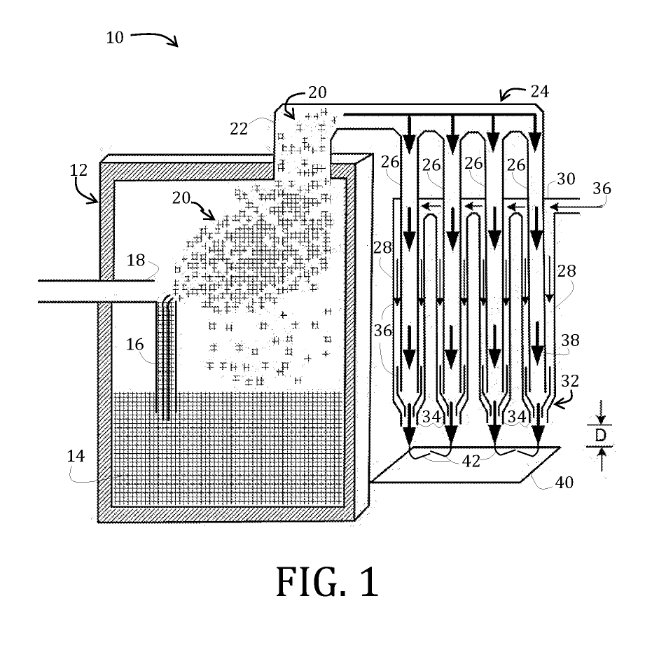

Referring now to the figures, and in particular to FIG. 1, a diagrammatic illustration of a conventional aerosol jet printing system 10 is shown in FIG. 1 and includes an atomizer module 12 for atomizing an electrolyte composition 14 contained therein. Mist generation of the electrolyte composition 14 may be achieved by using a mist generator (for example, ultrasonic or pneumatic atomization). As illustrated, the atomizer module 12 includes pneumatic atomization with a capillary 16 positioned proximate to an inert gas outlet 18. In this way, as inert gas, which may be air or nitrogen (for example), exits the outlet 18, electrolyte composition 14 within the capillary 16 may be atomized to form an aerosol stream 20.

The inert gas may also aid in directing the aerosol stream 20 toward an exit 22 of the atomizer module 12, the exit 22 being operably coupled to a droplet deposition module 24.

Within the deposition module 24, the aerosol stream 20 may be concentrated and directed into a plurality of channels 26. A sheath gas channel 28 is annular and co-axial to each of the plurality of channels 26 and is operably coupled to a sheath gas inlet 30. The deposition module 24 therefore includes a deposition head 32 having a plurality of sheath gas channels 28, each of which is annular and co-axial to a respective channel 26 that ends in a nozzle 34. In use, the sheath gas, indicated by arrow 36, and electrolyte composition 14, indicated within the channels by arrow 38, flow into respective channels 28, 26, exiting at respective nozzles 34, and are directed toward a substrate 40 that is positioned at a distance, D, away from the nozzles 34. In this way, the sheath gas is configured to focus the streams of electrolyte composition 42 emitted from the nozzles 34. In some embodiments, the streams 42 may have a diameter that may be as small as a tenth of a diameter of an orifice of the nozzle emitting the electrolyte composition.

Aerosol jet printing, such as by the exemplary device of FIG. 1, may be conducted at temperatures ranging from less than about 10° C. to about 150° C. or, in some instances, higher. An operating temperature of aerosol jet printing is selected based on the viscosity of the print solution, which according to embodiments herein, the electrolyte composition 14.

Aerosol jet printing has the advantage of being able to print fine lines, ranging in thickness from about 5 μm to about 15 μm, at higher deposition rates and higher solids loadings as compared to other printing techniques. The thickness of the deposited material may range from about 0.5 μm to about 300 μm or more; this resolution may be maintained over bumpy or non-uniform substrates because the velocity of the jetting ink is such that stream focus may be maintained for up to 5 mm. The viscosity of the printable electrolyte composition for use with an aerosol jet printer may range from about 1 mPa·s to about 2000 mPa·s or from about 5 mPa·s to about 1000 mPa·s. By comparison, the viscosity of the printable electrolyte composition using thermal jet printing or piezoelectric jet printing may range from about 1 mPa·s to about 25 mPa·s.

Patterning the electrolyte composition 14 on the substrate 40 may be achieved by attaching the substrate 40 to a computer-controlled platen or by translating the deposition head 32 while the substrate 40 position remains fixed. The aerosol jet printing process may, according to some embodiments, be CAD driven using a standard *.dxf (drawing exchange file).

A distance, D, between the nozzles 34 and the substrate 40 may be relatively large compared to the diameter of the nozzle 34 or the diameter of the streams 42. For example, D may range from about 3 mm to about 10 mm. Accordingly, the aerosol jet printer 10 may be used to deposit material on non-planar substrates, over existing structures, or into channels.

According to an embodiment of the present invention, the electrolyte composition 14 may be used to form an electrolyte directly onto a conductor substrate using standard atmospheric conditions (that is, without, or as opposed to, dry room conditions). The electrolyte composition comprising a solvent (or a mixture of solvents) that is non-reactive or are reversibly reactive with moisture and additional certain characteristics, such as: (1) a boiling point under standard atmospheric conditions that ranges from about 50° C. to about 225° C.; (2) a dielectric constant that is sufficient to dissociate a lithium salt; (3) is configured to dissolve an amount of an organic polymer so that it may be used as support matrix for the electrolyte; and (4) is configured to be printable. For printability, the electrolyte should have a viscosity ranging from about 1 mPa·s to about 2000 mPa·s, from about 10 mPa·s to about 500 mPa·s, or from about 20 mPa·s to about 100 mPa·s.

Solvents that may be suitable for the electrolyte compositions 14 may be selected from aliphatic hydrocarbons (such as octane), alcohols (such as 2-butanol or diacetone alcohol), t-butyl acetate, acetonitrile, ethylene carbonate, propylene carbonate, diethyl carbonate, dibutyl ketone, N-methyl-2-pyrrolidone, N-butyl pyrrolidone, n-propyl propionate, n-butyl propionate, methyl n-propyl ketone, methyl isobutyl ketone, methyl ethyl ketone, methyl isopropenyl ketone, methyl oleate, or combinations thereof.

Exemplary mixtures of solvents that may have the above identified characteristics are shown in the following table, wherein the volume percent listed in the table are based on 100% of the total solvent composition.

The boiling points of the solvent or mixture of solvents may range from about 50° C. to about 225° C. or from about 80° C. to about 180° C., such as from about 90° C. to about 150° C. The amount of solvent in the electrolyte composition 14 may range from about 50 wt % to about 98 wt % of the electrolyte composition 14. The electrolyte composition may range from about 75 wt % to about 95 wt % solvent, based on a total weight of the electrolyte composition.

The electrolyte composition further comprises a polymer. Suitable polymers, according to various embodiments of the present invention include polymers that are configured to conduct lithium ions and that are non-reactive or are reversibly reactive with water. Suitable polymers may have a number average molecular weight ranging from about 5 kDa to about 5 MDa, from about 10 kDa to about 100 kDa, or from about 15 kDa to about 50 kDa. The polymer should also be compatible with the solvent(s) and a lithium salt. Suitable ion conducting polymers may include, for example, polyalkylene oxides or polyalkylene glycols (including polyethylene oxide, polyethylene glycol, and polypropylene), glycol, polyvinylidene difluoride, polypropylene glycol dimethyl ether, and polymethacrylic acid. The amount of polymer in the electrolyte composition 14 may range from about 1 wt % to about 50 wt % of the electrolyte composition 14, such as from about 5 wt % to about 20 wt % or from about 10 wt % to about 15 wt %. Other exemplary polymers may include, for example, those provided in J. MINDEMARK et al., “Beyond PEO—Alternative host materials for Li⁺-conducting solid polymer electrolytes,” Progress in Polymer Sciences, Vol. 81 (2018) 114-143.

According to some embodiments of the present invention, the polymer may be used in a polymerized state that does not require post-print curing or polymerization. As such, according to some embodiments of the present invention, the electrolyte composition may be substantially devoid of photoinitiators, polymerization initiators, cross-linking agents, catalysts, or curing agents.

For embodiments in which the electrolyte composition 14 is printable, a weight ratio of solvent-to-polymer may range from about 2:1 to about 99:1, from about 5:1 to about 80:1, or from about 10:1 to about 60:1. Greater solvent content may be necessary for electrolyte compositions 14 using higher molecular weight polymers; lesser solvent content may be necessary for electrolyte compositions 14 using lower molecular weight polymers. Such adaptation of solvent content may necessary to provide composition having a desired and printable viscosity.

For those embodiments in which the electrolyte composition 14 is printed onto a conductive substrate, the polymer may be configured as a solid polymeric matrix through which lithium ions flow to the cathode of the battery as the battery discharges. Since the electrolyte composition 14 is a solid (rather than a liquid), there are no toxic liquids to leak from such a battery, which reduces or eliminates safety concerns.

The electrolyte composition further comprises lithium ions. In that regard, a lithium salt may be mixed with the polymer. Suitable lithium salts include those that are non-reactive or are reversibly reactive with water. Exemplary lithium salts may include lithium trifluoromethane sulfonate, lithium bis(oxalato) borate, lithium difluoro(oxalato) borate, poly[(4-styrenesulfonyl)(trifluoro-methyl(S-trifluoromethyl-sulfonylimino)sulfonyl)imide], or other hydrophilic lithium salts (such as lithium bis(trifluoromethanesulfonyl)imide). Other salts may also be used with the proviso that the salt should not result in a strong acid in the presence of water (for example, LiPF₆ or LiBF₄). A polymer-to-lithium ion ratio (for example, ethylene oxide moieties in the polymer-to-lithium ions in the lithium compound) of the electrolyte composition 14 may range from about 6:1 to about 40:1, from about 10:1 to about 30:1, or from about 15:1 to about 25:1.

TABLE 1
EXEMPLARY SOLVENT MIXTURES

| | VOL | | |
|---|---|---|---|
| SOLVENT 1 | % | SOLVENT 2 | VOL % |
| n-propyl propionate | 65 | propylene carbonate | 35 |
| t-butyl acetate | 57 | propylene carbonate | 43 |
| ethylene carbonate | 35 | methyl oleate | 65 |
| methyl propyl ketone | 76 | propylene carbonate | 24 |
| n-butyl propionate | 66 | propylene carbonate | 34 |
| aliphatic hydrocarbon (octane) | 23 | N-methyl-2-pyrrolidone | 77 |
| methyl ethyl ketone | 83 | propylene carbonate | 17 |
| methyl propyl ketone | 55 | N-methyl-2-pyrrolidone | 45 |
| methyl isobutyl ketone | 66 | propylene carbonate | 34 |
| methyl isobutyl ketone | 41 | N-methyl-2-pyrrolidone | 59 |
| methyl ethyl ketone | 65 | N-methyl-2-pyrrolidone | 35 |
| propylene carbonate | 80 | Diethyl carbonate | 20 |

The electrolyte composition may further comprise an ionically-conducting, solid inorganic filler. Suitable inorganic fillers may include a ceramic; an oxide; a sulfide; a phosphate-based, lithium-ion conducting ceramic; or a phosphate-based, lithium-ion conducting glass. Oxide fillers include, but are not limited to, garnet materials (such as Li_{6.4}La₃Zr₂Al_{10.2}O₁₂, Li₇La₃Zr₂O₁₂, Li₇La_{2.75}Ca_{0.25}Zr_{1.75}Nb_{0.25}O₁₂, Li₅La₃Nb₂O₁₂, and Li_{6.5}La₃Nb_{1.25}Y_{0.75}O₁₂). Sulfide fillers include, but are not limited to, LiI—Li₂S—P₂S₅; LiI—Li₂S—B₂S₃; LiI—Li₂S—SiS₂; (1-x-y)Li₂S_{.x}GeS_{2y}P₂S₅, where 0≤x<0.5 and 0≤y≤0.4; Li₄₋ₓGe₁₋ₓPₓS₄, where 0.2<x≤0.9; and (1-x)Li₂SₓP₂S₅, where 0.15≤x<0.5. Phosphate-based, lithium-ion conducting ceramic and glass fillers may include, but are not limited to Li_{1.3}Al_{0.3}Ti_{1.7}Si_{0.4}P_{2.6}O₁₂, Li_{1.5}Al_{0.5}Ge_{1.5}(PO₄)₃, Li_{1.4}Cr_{0.4}(Ge_{0.4}Ti_{0.6})_{1.6}(PO₄)₃, and Li₂OAl₂O₃TiO₂P₂O₅. Still other fillers may include the examples provided in F. ZHENG et al., “Review on solid electrolytes for all-solid-state lithium-ion batteries,” J. Power Sources, Vol. 289 (2018) 198-213. The amount of inorganic filler that may be present in the electrolyte composition may range from about 0 wt % to about 99 wt %, based on a total weight of solids in the printable electrolyte composition.

Printable electrolyte compositions according various embodiments of the present invention may be suitable for use with drop-on-demand printing techniques, such as aerosol jet printers, thermal j et printers, and piezoelectric jet printers. Such printers may be operated under standard atmospheric conditions and without the need for a dry room. With the foregoing printers, the viscosity of the printable electrolyte composition may range from about 1 mPa·sec to about 25 mPa·sec. Accordingly, the amount of solvent may be greater for drop-on-demand or piezoelectric embodiments as compared to embodiments suitable for use with aerosol jet printers. Similarly, the molecular weight of the polymer used in drop-on-demand or piezoelectric embodiments may be lower than with electrolyte compositions suitable for use with aerosol jet printers. However, the resulting, printed solid electrolyte is expected to be similar to, and have similar properties to, that of the foregoing aerosol jet printed electrolyte composition when printed under standard atmospheric conditions.

According to other embodiments of the present invention, a solid-state battery may be formed using one of the solid electrolyte compositions described above according to the various embodiments of the present invention. In preparing such solid state battery, an anode current collector (negative) and a cathode current collectors (positive) may be deposited or otherwise printed onto a suitable substrate. The suitable substrate may be, for example, a ceramic, a semiconductor metal, or a polymeric material. More specifically, suitable substrates may include glass, alumina, sapphire, silicon, plastic, lithium metal, and so forth. The current collectors may comprise a thin metal film of electrically conductive oxides. Metals of the thin metal film may be selected from noble and transition metals, such as gold, platinum, vanadium, cobalt, nickel, manganese, niobium, tantalum, chromium, aluminum, copper, molybdenum, titanium, zirconium, tungsten, and so on, or alloys thereof.

One particular embodiment may include a metallic cathode current collector comprising a 300 Å thick transition metal film, preferably cobalt (LiCoO₂ cathode) or manganese (for a LiMn₂O₄ cathode). Material for the anode current collector may be selected from copper, titanium, or tantalum. For lithium-ion thin film batteries having inorganic or metallic anodes (such as tin oxide (SnO₂), tin nitride (Sn₃N₄), zinc nitride (Zn₃N₂), silicon (Si), and tin (Sn)), a suitable anode current collector may be copper, for example.

The anode and cathode current collector material may be deposited onto the substrate by radio frequency or direct current magnetron sputtering, diode sputtering in an argon atmosphere, vacuum evaporation, or other deposition techniques conventionally used by the semiconductor electronics industry. Each of the anode and cathode current collectors have a thickness typically ranging from about 0.1 μm to about 0.3 μm.

With cathode current collector deposition complete, a conductive cathode thin film may be deposited over a portion of the cathode current collector. The cathode thin film may be a metal oxide, such as a transition metal oxide, wherein the metal of the metal oxide is the same as the metal of the current collector. Suitable conductive cathode thin film materials may include, but are not limited to, lithium transition metal oxides (such as LiCoO₂, LiNiO₂, LiMn₂O₄, LiCo₍₁₋ᵥ₎NiᵥO₂, and the like, where 0.5≤v≤1.0), and transition metal oxides (such as crystalline or amorphous vanadium pentoxide (V₂O₅)). The conductive cathode thin film may have a thickness ranging from 1 μm to 300 μm and may be deposited by tape casting or printable by a drop-on-demand printer, for example.

A lithium containing electrolyte composition according to an embodiment of the present invention may then be printed onto the conductive cathode film as described above, under standard atmospheric conditions, to provide the solid lithium-containing electrolyte.

Construction of the solid-state thin-film battery may be completed by depositing a metallic anode over a portion of the electrolyte composition. The metallic anode may be deposited by tape casting, printable by a drop-on-demand printer, evaporation or sputtering techniques and has a thickness typically ranging from about 1 am to about 150 am. For lithium-ion thin film batteries, the anode may be lithium, silicon, tin, metal nitrides, or metal oxides. Metal nitrides (such as Sn₃N₄ and Zn₃N₂) may be formed by sputtering tin or zinc in a pure nitrogen gas atmosphere. Inorganic anodes of metal oxides (such as SnO₂) may be deposited by reactive sputtering of the base metals in an atmosphere of argon and oxygen. In an alternative, the anode may be a graphite-based anode that is printed onto the solid electrolyte.

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

### Example 1—Printable Electrolyte Compositions

Exemplary compositions according to embodiments of the present invention that may be deposited using aerosol jet printers, such as the printer 10 illustrated in FIG. 1, are shown Table 2. In Table 2, polyethylene oxide 1 has a viscosity average molecular weight of 100 kDa and polyethylene oxide 2 has a viscosity average molecular weight of 35 kDa. The weight ratio of propylene carbonate-to-diethylcarbonate, when used in the solvent, was 4:1. Lithium trifluoromethane sulfonate was used as the lithium compound with a polymer-to-lithium ratio (ethylene oxide moieties in the polymer-to-lithium ions in the lithium compound) of 16:1.

Each formulation was made by mixing the lithium compound with a sufficient portion of the solvent to dissolve the lithium compound. The mixture of solvent and lithium compound was mixed with the polymer in the ratios according to embodiments of the present invention and so as to provide the printable electrolyte compositions.

TABLE 2
PRINTABLE ELECTROLYTE COMPOSITIONS

| | | Polymer | |
|---|---|---|---|
| Formulation | | Loading | |
| No. | Polymer | (wt %) | Solvent(s) |
| 1 | polyethylene oxide 1 | 5 | propylene carbonate |
| | | | diethylcarbonate |
| 2 | polyethylene oxide 2 | 7.5 | propylene carbonate |
| | | | diethylcarbonate |
| 3 | polyethylene oxide 3 | 5 | diacetone alcohol |
| 4 | polyethylene oxide 4 | 10 | diacetone alcohol |
| 5 | polyethylene oxide 5 | 10 | diacetone alcohol |
| 6 | polyethylene oxide 6 | 10 | diacetone alcohol |

An aerosol jet printer was used to print the electrolyte compositions onto an electrode substrate made of a lithium transition metal oxide. The aerosol jet printer had a 10 mm nozzle, a platen temperature of 50° C., a sheath gas flow rate of 1000 cc/min, an atomization gas flow rate of 1500 cc/min, a platen speed of 100 mm/sec, a step size of 0.5 mm, a D of 9 mm, and a deposition rate of about 0.008 g/min. Printed compositions were then vacuumed dried. The printable electrolyte compositions had a temperature of 40° C. The average thickness of the film after 100 passes was approximately 50 am.

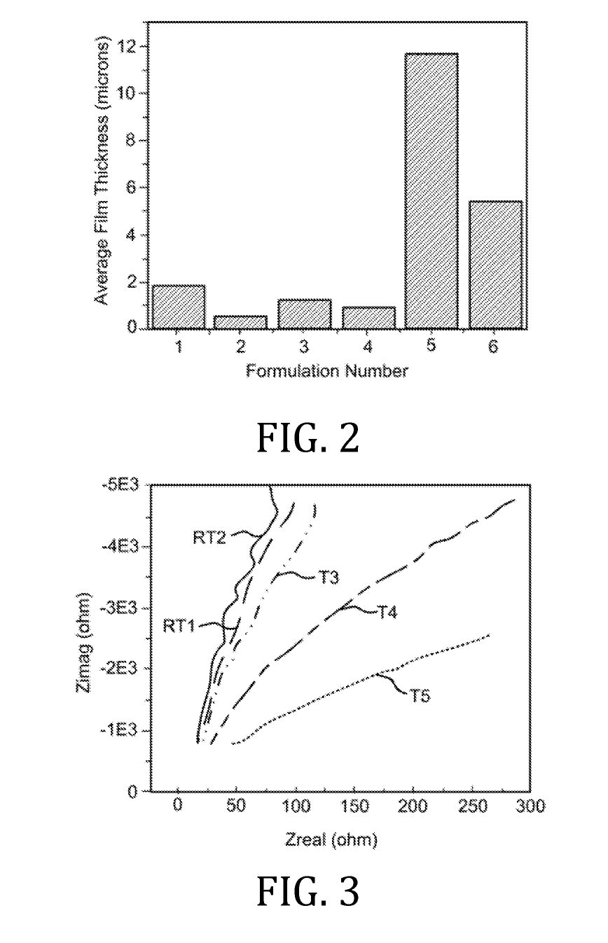

The resulting film thickness for each formulation is shown in FIG. 2. The solid electrolyte films produced by the aerosol jet printer were pinhole free and had seamless contact between the printed material and the substrate. Seamless contact is important for minimizing internal resistance in a solid-state battery operating below the melting point of the polymer, i.e., temperatures of less than about 60° C. to 65° C. Minimizing internal resistance of the battery is believed to be important for improving the battery performance. Unlike a tape casting process, the aerosol jet printing process enables the formation of a dense electrolyte material that may be deposited at relatively low temperatures directly onto a cathode substrate.

The conductivities achievable from the polymer films printed under standard conditions are comparable to those achievable by polyethylene oxide/lithium triflate films processed solely in a dry room.

### Example 2—Conductivity

In order to determine how well the printed electrolytes perform in a battery, a sample of the electrolyte composition according to Formulation 6 of Table 2, above, was printed with a thickness ranging from about 10 μm to 12 μm with an aerosol jet printer on battery grade aluminum foil. The printed film was dried in a vacuum.

The printed sample on aluminum foil was then tested for in-plane conductivity using a two-lead probe and for through thickness conductivity using electrochemical impedance spectroscopy (“EIS”) in a two electrode Teflon fixture. The printed sample had a resistance ranging from about 100Ω to 300Ω. EIS measurements of the printed sample were taken twice at room temperatures: RT1 and RT2 of 21.3° C.; and at other temperatures: T3 of 30° C., T4 of 40° C., and T5 of 50° C.

The Nyquist plot of FIG. 3 was derived from temperature dependent EIS of the printed sample. The data in the trace labeled RT1 was obtained at the beginning of the conductivity test. Conductivities were measured at each of T3, T4, and T5. After conductivity was measured at T5, the film was cooled to RT2 and conductivity measured again. The conductivity of the printed sample was calculated to be about 2.8×10⁻⁵ S/cm using the equation K=l/RA, wherein K is conductivity, l is film thickness, R is film resistance (approximated by the high frequency intercept with the real axis), and A is film area. The calculated conductivity was comparable to the conductivity of the same material processed solely in dry room conditions.

### Example 3—Coin Cell Batteries

Three coin cell batteries were made using a hybrid polymer/inorganic electrolyte comprising lithium aluminum germanium phosphate (“LAGP”), polyethylene oxide polymer (“LAGP/PEO”), and lithium trifluoromethane sulfonate (lithium triflate) salt. The electrolyte formulation included 84.09 wt % acetonitrile, 2.5 wt % lithium triflate salt, 2.05 wt % LAGP, and 11.36 wt % polyethylene oxide.

Electrolyte ink was printed on a cathode tape with a thickness of about 13 μm and an area of about 25.8 cm². The cathode tape was a commercially-available cathode tape from MTI, Inc. The cathode material was lithium cobalt dioxide coated onto a 15 μm thick aluminum foil current collector with a thickness of about 40 μm.

After the electrolyte was dried under vacuum, the electrolyte used in preparing three coin cell batteries by pairing the cathode and printed electrolyte with a lithium metal foil anode.

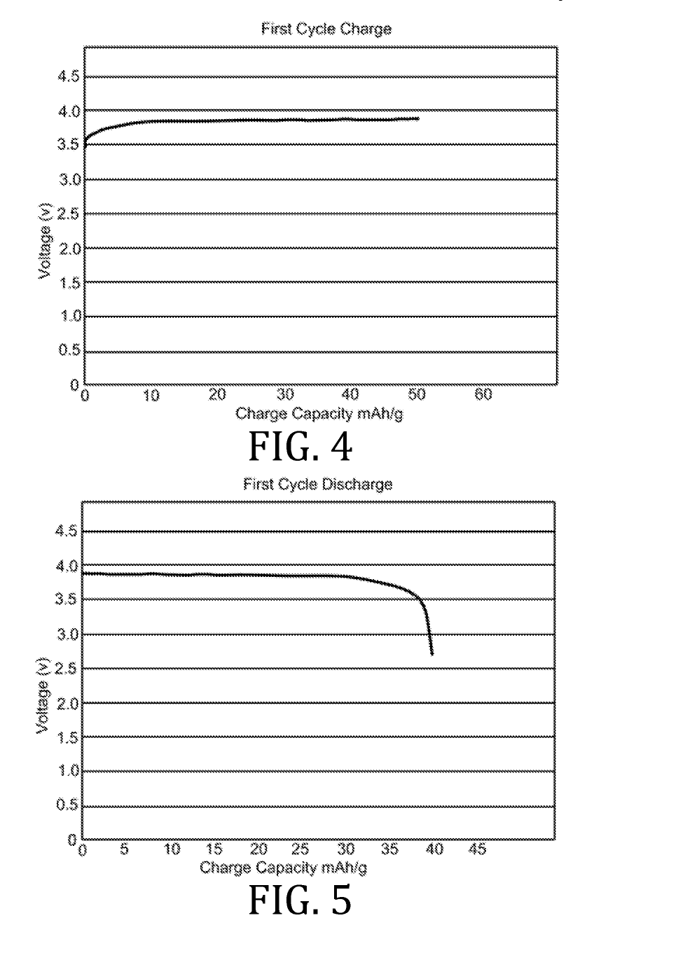

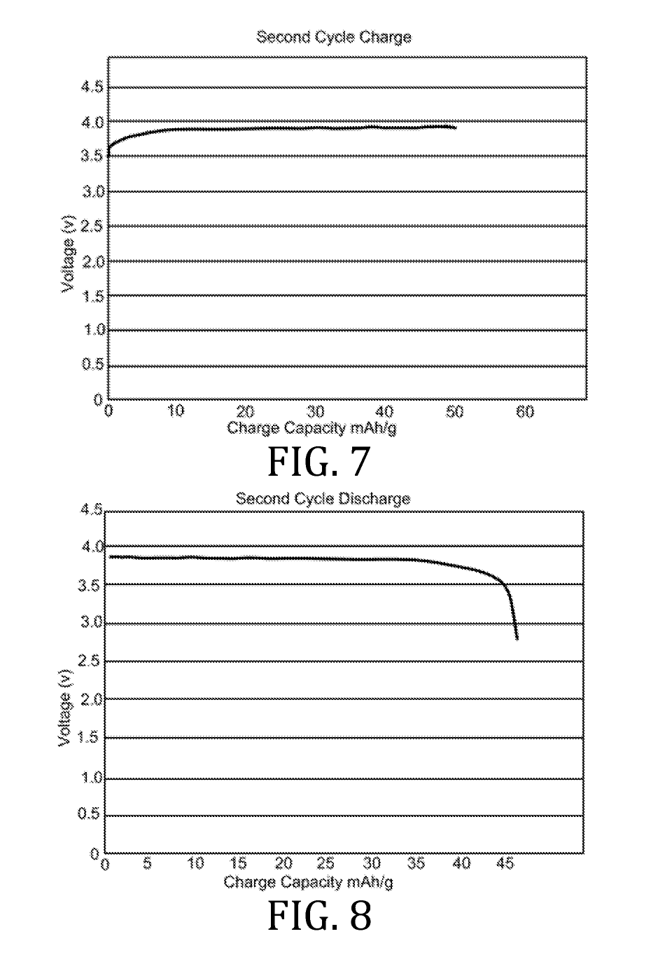

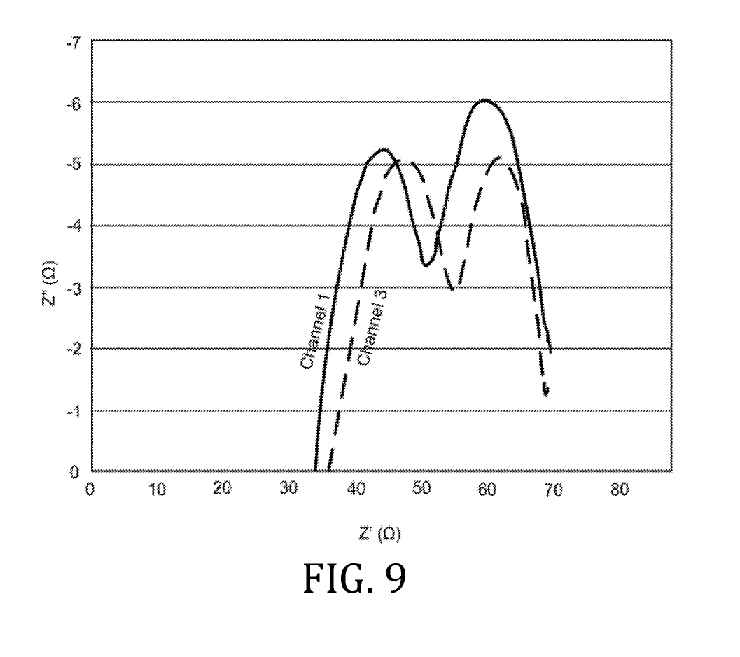

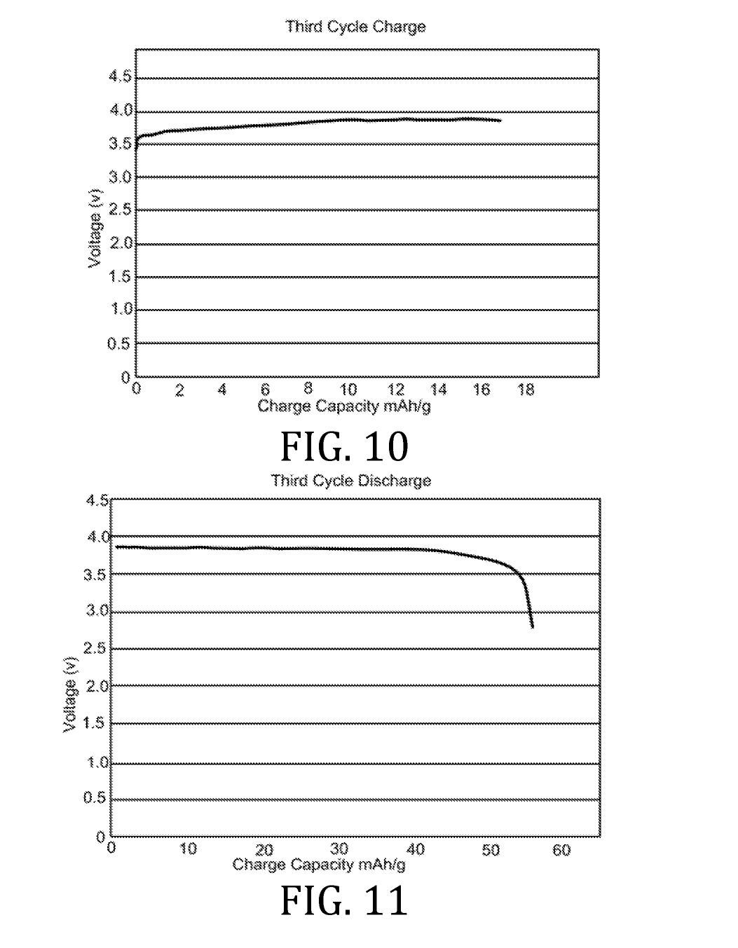

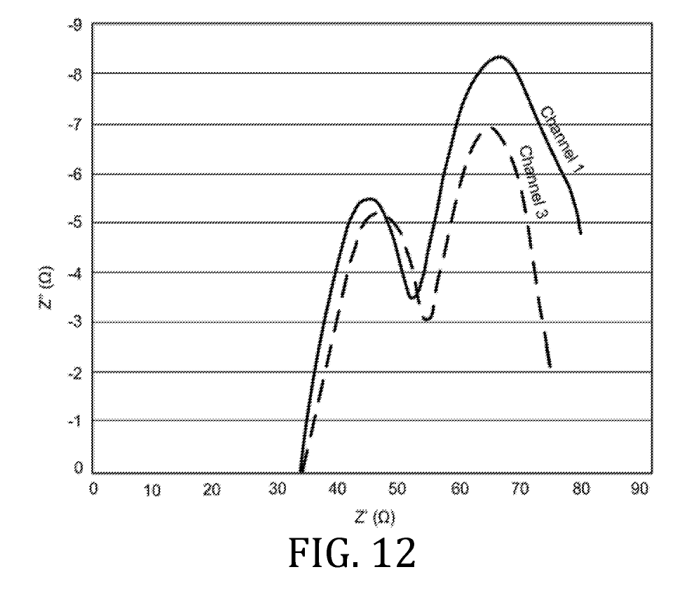

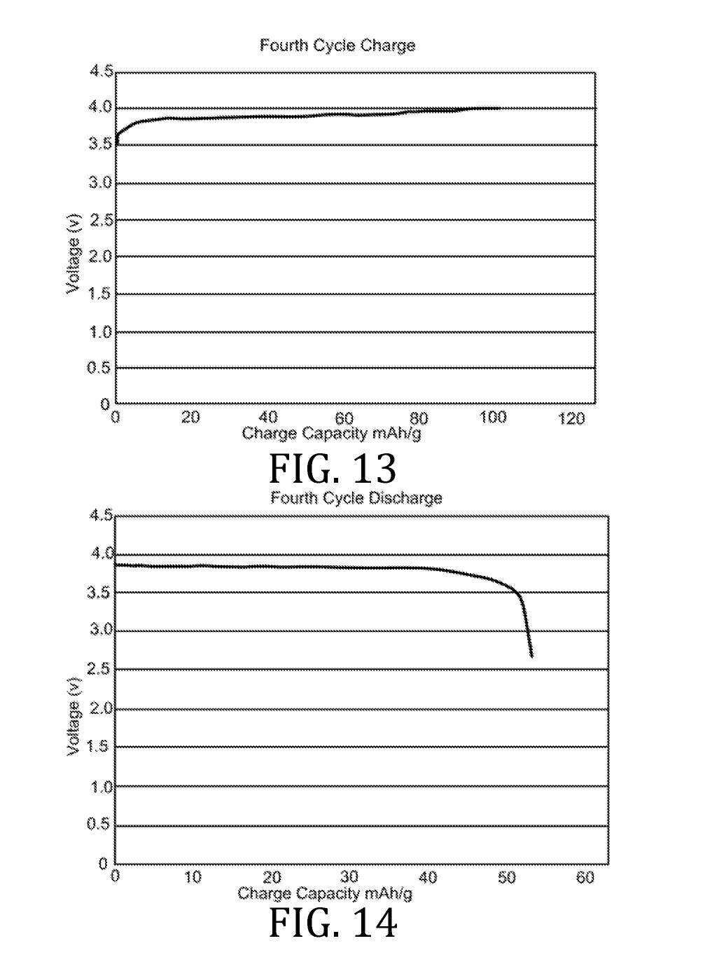

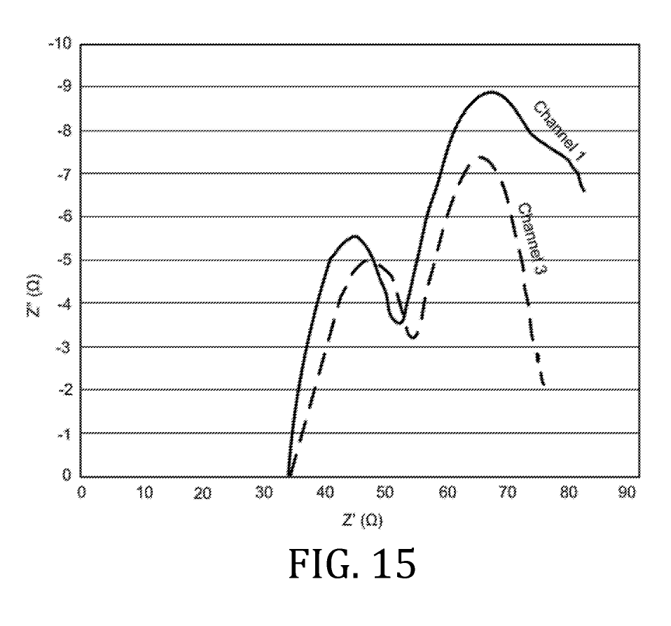

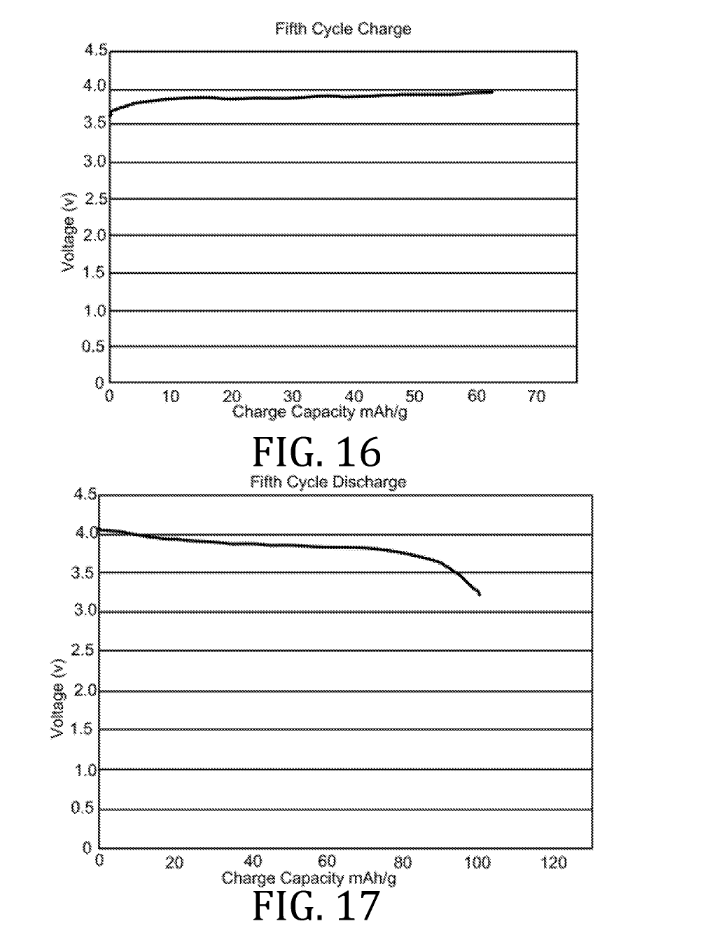

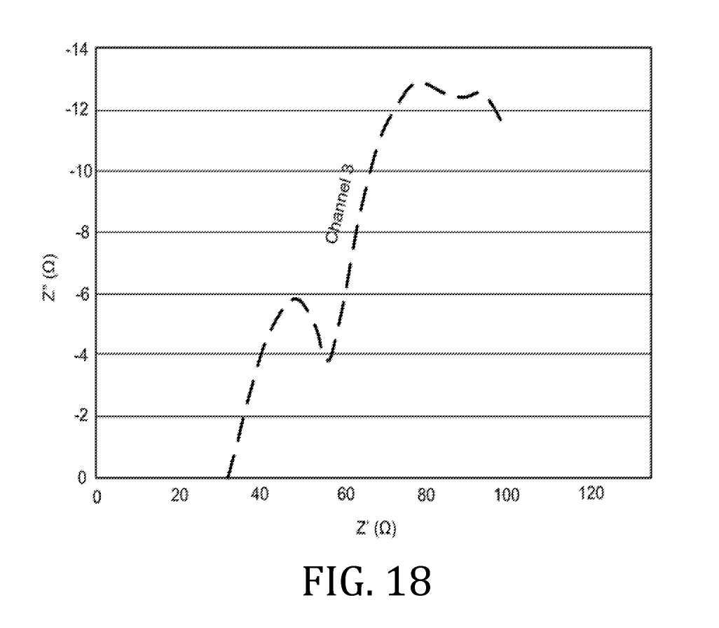

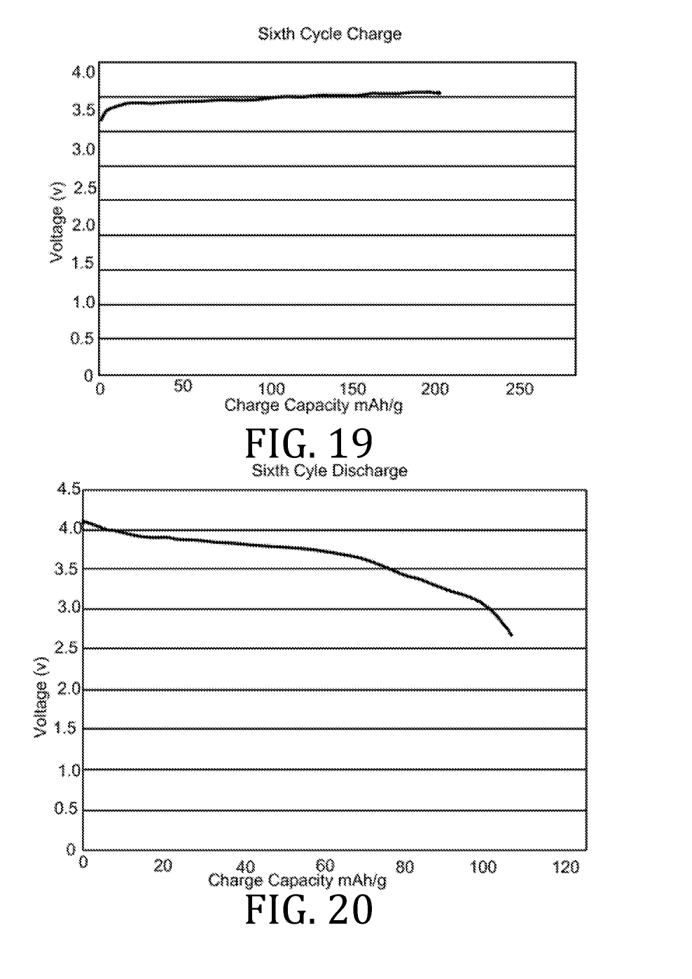

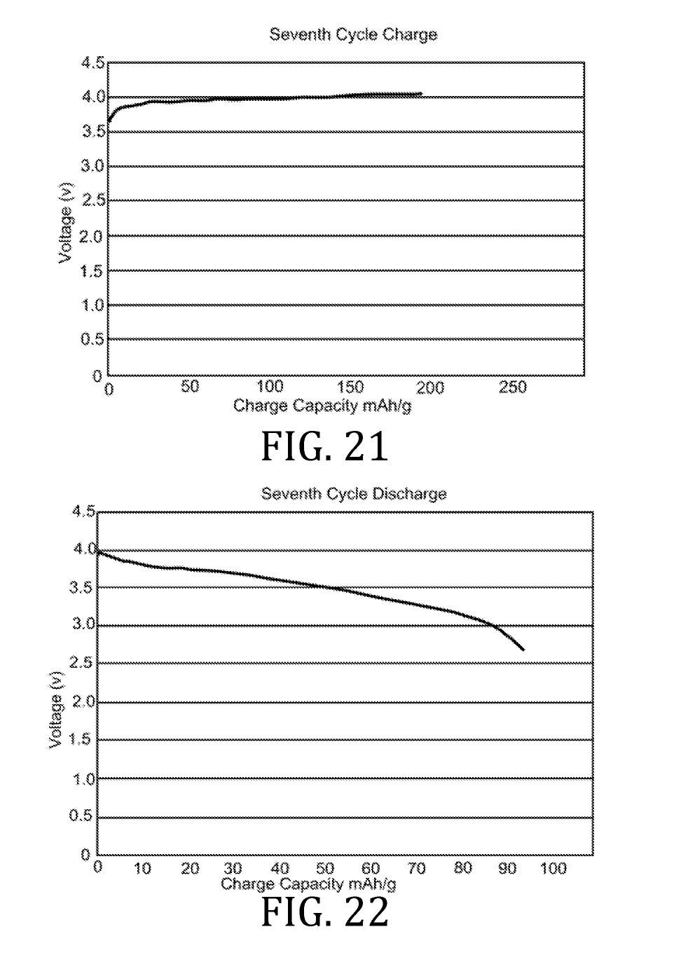

FIGS. 4-22 present data corresponding to batteries made from hybrid polymer/ceramic electrolyte films that were aerosol jet printed under standard conditions. The data in FIGS. 4, 5, 7, 8, 10, 11, 13, 14, 16, 17, and 19-22 illustrates multiple charge discharge cycles for the above described coin cell batteries. The batteries were charged at 44 μA at 85° C.

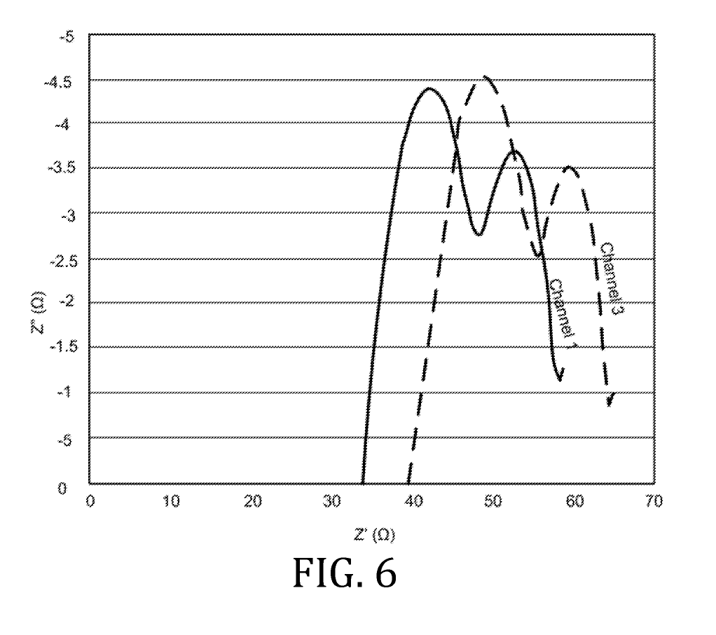

FIGS. 6, 9, 12, 15, and 18 are Nyquist plots derived from electrochemical impedance spectroscopy measurements performed at 85° C. on the three coin cell batteries. Channels 1 and 3 represent data obtained from two of three coin cell batteries. Since the materials, printing, processing, and fabrication of the three coin cell batteries were all the same, the data obtained from all three batteries were expected to be the same; however, small differences in the batteries (alignment of materials, exact spring constant of the spring element in the coin cell batteries, etc.) account for small differences in the data.

The data from FIGS. 6, 9, 12, 15, and 18 demonstrate where the curves in the Nyquist plot intercept the X-axis. The X-axis intercept is the real portion of the complex number that represents the impedances of the cell. In FIGS. 6, 9, 12, 15, and 18, there are two locations where the curves in the Nyquist plots intercepted the X-axis. The first intercept corresponds to impedance measurement performed at high frequency (known as the high frequency intercept) and is associated with the interfacial resistance in the battery. The high frequency intercept value appeared to be about 35Ω for the coin cell batteries. The second intercept corresponds to impedance measurement performed at low frequency and is associated with the bulk resistance in the electrolyte. For the coin cell batteries, the low frequency intercept was about 65Ω.

The values of interfacial and bulk resistances were measured for the coin cell batteries made with the printed electrolytes described above and were comparable to resistances of batteries made with similar materials in a dry room.

By comparing FIGS. 6, 9, 12, 15, and 18, an evolution of impedance in each battery as a function of charge cycle may be traced. While there were some small increases in impedance as a function of charge cycle, these increases were minimal, which indicates the batteries were stable over the observed, five charge cycles.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

1. A printable composition for a solid lithium ion electrolyte, the composition comprising:
a solvent having a boiling point under standard atmospheric conditions ranging from about 50° C. to about 225° C.;
a polymer; and
a lithium salt;
wherein the composition is stable, has a viscosity ranging from about 1 mPa·s to 2000 mPa·s and is printable by a drop-on-demand printer under standard temperature and pressure conditions.

2. The printable composition of claim 1, wherein the lithium salt is lithium trifluoromethane sulfonate, lithium bis(oxalato) borate, lithium difluoro(oxalato) borate, poly[(4-styrenesulfonyl)(trifluoro-methyl(S-trifluoromethyl-sulfonylimino)sulfonyl)imide], lithium bis(trifluoromethanesulfonyl)imide), or combinations thereof.

3. The printable composition of claim 1, wherein the composition is printable in an atmosphere with a relative humidity ranging from about 0% to about 80%.

4. The printable composition of claim 1, wherein the composition is printable in a dry room.

5. The printable composition of claim 1, wherein the solvent is an aliphatic hydrocarbons, an alcohol, t-butyl acetate, acetonitrile, ethylene carbonate, propylene carbonate, diethyl carbonate, dibutyl ketone, N-methyl-2-pyrrolidone, N-butyl pyrrolidone, n-propyl propionate, n-butyl propionate, methyl n-propyl ketone, methyl isobutyl ketone, methyl ethyl ketone, methyl isopropenyl ketone, methyl oleate, or combinations thereof.

6. The printable composition of claim 5, wherein the solvent solve is octane, 2-butanol diacetone alcohol, or combinations thereof.

7. The printable composition of claim 1, wherein the polymer is a polyalkylene oxide, a polyalkylene glycol, a polyvinylidene difluoride, a polypropylene glycol dimethyl ether, a polymethacrylic acid, or combinations thereof.

8. The printable composition of claim 7, wherein the polyalkylene glycol is polyethylene oxide, polyethylene glycol, or polypropylene glycol.

9. The printable composition of claim 1, wherein a ratio of ethylene oxide moieties in the polymer-to-lithium ions in the lithium compound in the electrolyte composition ranges from about 6:1 to about 40:1.

10. The printable composition of claim 1, wherein a number average molecular weight of the polymer ranges from about 5 kDa to about 5 MDa.

11. The printable composition of claim 1 wherein a weight ratio of solvent-to-polymer ranges from about 2:1 to about 99:1.

12. The printable composition of claim 1, wherein the drop-on-demand printer is an aerosol jet printer, a thermal jet printer, or a piezoelectric jet printer.

13. The printable composition of claim 1, further comprising:
an ionically-conducting, solid inorganic filler.

14. The printable composition of claim 13, wherein the inorganic filler is a ceramic filler, an oxide filler, a sulfide filler, a phosphate-based lithium-ion conducting ceramic filler, a phosphate-based lithium-ion conducting glass filler, a sodium super ionic conducting ceramic filler, or combinations thereof.

15. The printable composition of claim 14, wherein the inorganic filler is alumina, a silica filler, titania, zirconia, or a combination thereof.

16. The printable composition of claim 14, wherein the inorganic filler is a sodium super ionic conducting ceramic filler.

17. A solid state electrolyte comprising:
the printed and dried printable composition of claim 1.

18. A battery comprising:
an anode;
a cathode; and
the solid state electrolyte of claim 17 between the anode and the cathode.

19-42. (canceled)
